(19) United States
(12) Patent Application Publication
(10) Pub. No.: US 2010/0190540 A1
(43) Pub. Date: Jul. 29, 2010

(54) Game based on guessing marker location

(76) Inventor: Dave Tahija, Butte, MT (US)

Correspondence Address: Dave Tahija, P.O. Box 488, Butte, MT, 59703, US

(21) Appl. No.: 12/322,280

(22) Filed: Jan. 29, 2009

(51) Int. Cl. A63F 13/00

(52) U.S. Cl. 463/16

(57) ABSTRACT

A game in which a Player begins with a number of Points and, in a series of bouts, attempts to guess the association of a concealed Marker with one of several displayed locations: a displayed Red Hand, displayed Blue Hand or displayed Cache. With each correct guess the Player accumulates an additional Point or Points. With each incorrect guess, the Player loses a Point. If the Player accumulates a predetermined number of Points, he wins the game and any associated wager. If the Player loses all his Points, he loses the game and any associated wager.

### CROSS REFERENCE TO RELATED APPLICATIONS

Not Applicable

### FEDERALLY SPONSORED RESEARCH

Not Applicable

### SEQUENCE LISTING OR PROGRAM

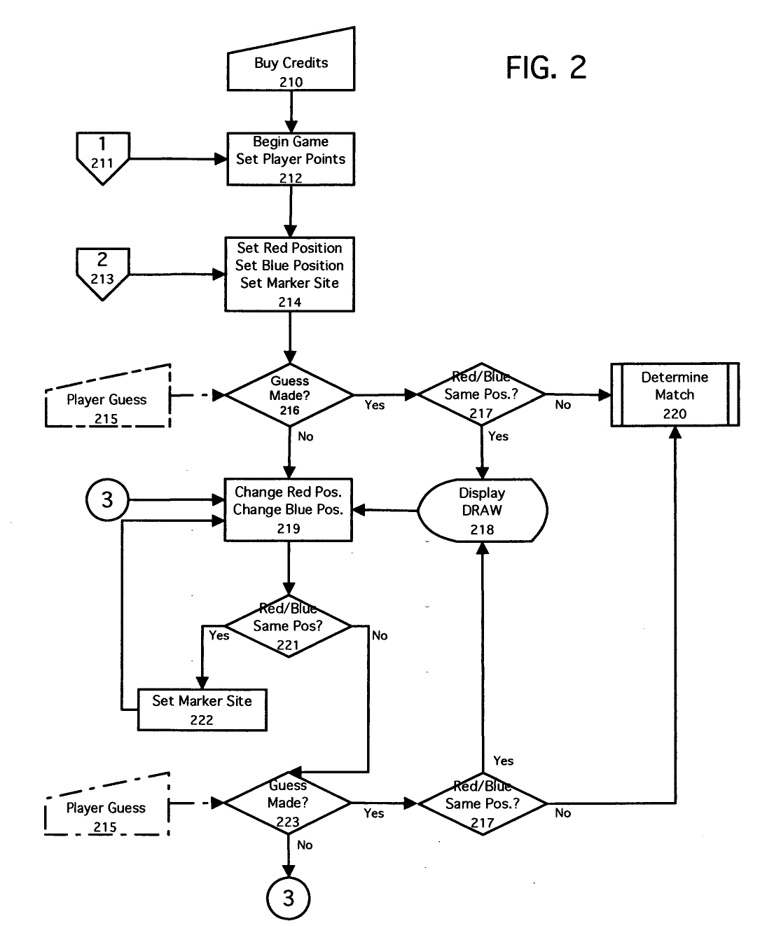

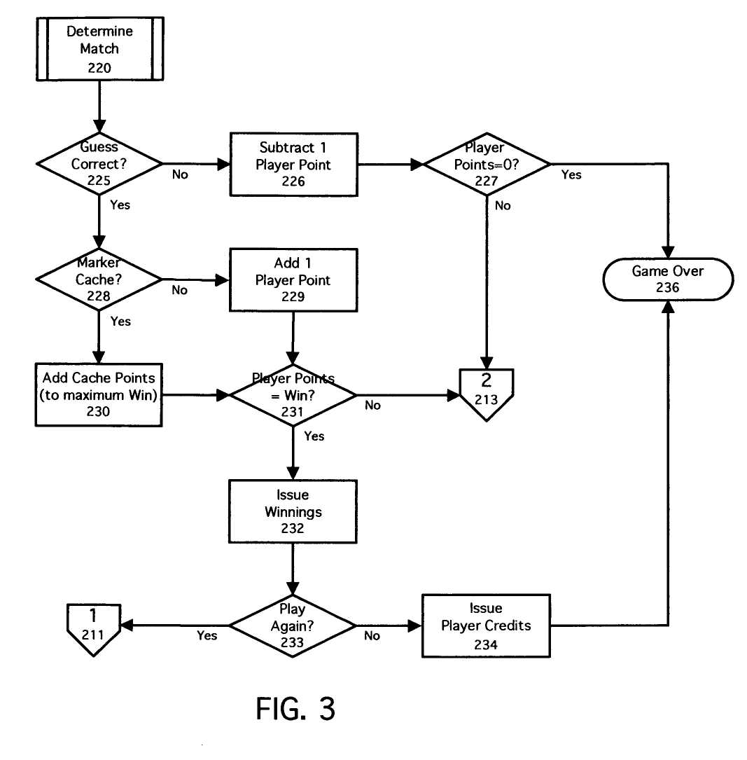

Program flow sheet included as FIGS. 2 and 3.

Working model of program supplied on CD as Appendix.

### BACKGROUND OF THE INVENTION

1. Field of Invention

This invention relates to gaming, specifically to electronic versions of traditional gambling games and variations of such games.

2. Prior Art

Hand, also known as the Stick Game or Bone Game, is a traditional North American Indian game, played by many tribes across a wide geographic area. Hand was widely played at the time of first European contact with the various Indian tribes and is presumed to be many centuries old. It is still played today, especially at pow-wows and other gatherings.

There are many variants but the basics of Hand are universal and simple. A game consists of a series of bouts. At the beginning of each bout, one player, often accompanied by several teammates, has control of a bone, stick or other marker, which is small enough to be concealed in his closed fist. Often to the accompaniment of a chant, he hides the bone in one fist or the other, at times changing the bone from one hand to the other or pretending to so change hands.

During each bout, the opposing player or players attempt to determine which hand the bone is in and announce the guess by pointing at or otherwise indicating the hand believed to contain the bone. If the guess is correct, the guessing side gains a point while the bone-holding side loses one. If the guess is incorrect, the guessing side loses a point while the bone-holding side gains one. Assuming the two sides each still retain at least one point, another bout then begins and the game goes on.

Commonly, the two sides start each game with an equal number of points. The game continues, with the two sides gaining and losing points until one side holds all the points and so wins the game. There is often a predetermined wager, which the winning side claims.

Hand can be an intense game, requiring great concentration as the players try either to deceive the other side as to the bone's location or to see through the deception and determine in which hand the opposing player is holding the bone. Individual or group spiritual power is often invoked as a means of concealing or detecting the location of the bone.

Electronic versions of many traditional games have been developed. Such games include video poker, video baccarat, video keno, video dice and video bingo. In addition, electronic versions of the mechanical slot machine have been developed. However, numerous traditional games, such as Hand, do not yet have electronic versions or equivalents.

### OBJECTS AND ADVANTAGES

I have developed a new game with superficial resemblances to traditional Hand but with significant additional objects and advantages.

Hand, as traditionally played, has no element of randomness: the bone-holding side sets and so always knows the location of the bone or other marker.

Hand, as traditionally played, has no house percentage or other means for the sponsor of the game to retain a portion of the wagered stakes. It is a double-or-nothing game with 100% of the wagered stakes paid to the winning side.

The new game allows for the location of the bone or other marker to be determined by a random process, such as a random number generator.

The new game allows for the possibility of a house percentage, by some additions and modifications to the traditional game. One such addition is the Cache, which provides an additional possible site for the bone, or Marker, besides the two Hands. Adjusting the statistical frequency of the bone's location in the Cache or either of the two Hands, plus adjustment of the number of points won by a correct guess, allows the house percentage to be statistically set to a desired level.

Another means of maintaining a house percentage is to initially provide a Player with less than exactly half the number of points needed to win the game. This makes it statistically more likely that the Player would lose rather than win the game.

### SUMMARY

In the preferred embodiment of this invention, an electronic video screen displays images representing two individual Hands (Red Hand and Blue Hand) and a Cache. A Marker is associated with one of the Hands or the Cache but normally has no visual or other external representation. When a Player deposits a wager and begins the game, he is awarded an initial number of Points, which are displayed on the screen.

A game consists of one or more bouts, played in series. During each bout, the images representing the Red and Blue Hands are periodically moved to various locations on the screen, possibly in time to a chant, song or other accompaniment supplied by the game mechanism. At least one location must be able to be occupied by both the Red and Blue Hands. The Cache is normally maintained in a fixed location on the screen. The Marker is associated with one of the Hands or the Cache. This association does not change as a result of the movement of the Hands unless the Hands are caused to occupy the same location on the screen.

When the two Hands are caused to occupy the same location, the Marker is assigned a new association with one of the Hands or with the Cache. The new association may be the same as the previous association or it may be different.

At any time except when the two Hands occupy the same location, the Player may guess whether the Marker is associated with the Red Hand, Blue Hand or Cache by pressing an appropriate button or location on the screen. After each valid guess, the Marker's association is revealed. If the Player has guessed correctly, he gains one or more Points. If the Player has guessed incorrectly, he loses a Point.

A new bout begins after each guess and the subsequent award or loss of Points, unless the Player has lost all his points or has accumulated enough Points to win the game.

The Player may not make a valid guess when the Red and Blue Hands occupy the same location. If he attempts to make a guess when they occupy the same location, the screen displays “Draw” or some message with similar meaning and play resumes. No Points are won or lost as a result of a “Draw” guess.

If the Player accumulates a predetermined number of Points, he wins the game and collects the wager. If he loses all his points, he loses the game and the wager.

The Player may be awarded more than one point as the result of a successful guess, especially for a successful guess of the Cache, but he may not accumulate more Points than are needed to win the game.

### DRAWINGS

### Figures

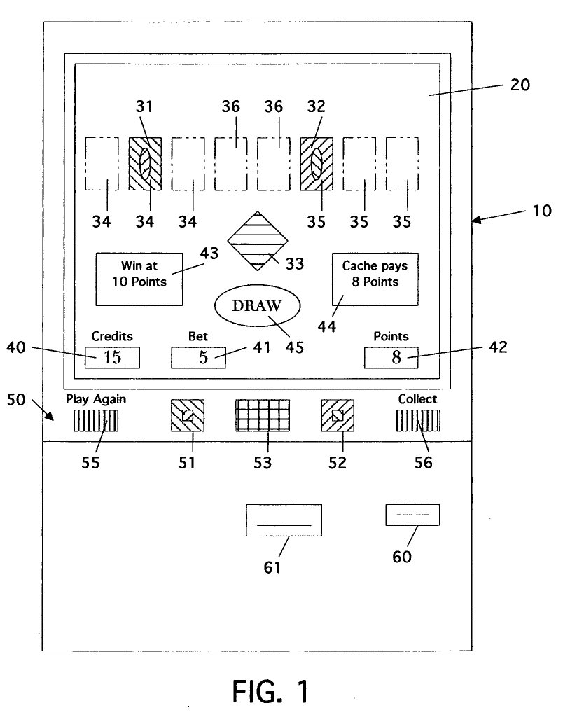

FIG. 1 is a representation of an electronic machine which can be used to play the new game.

FIG. 2 is a flow chart of the overall play of the new game.

FIG. 3 is a flow chart of the process within the new game which decides whether the Player's guess is correct, adds or removes Player Points depending on the result, decides whether the Player has won or lost the game and, if the Player has not won or lost, returns the play to the game for a new bout, as depicted in FIG. 2.

### DETAILED DESCRIPTION

### FIG. 1

FIG. 1 is a general view of a gaming machine 10 which can be used to play the new game. The gaming machine 10 includes a video screen 20 on which is displayed the Red Hand image 31, the Blue Hand image 32 and the Cache image 33.

The images representing the Red and Blue Hands can move during the course of the game. The Red Hand image 31 can solely occupy any of several Red Hand locations 34. The Blue Hand image 32 can solely occupy any of several Blue Hand locations 35. Both the Red Hand image 31 and Blue Hand image 32 can occupy the Red/Blue locations 36, either simultaneously or separately.

The video screen 20 also can show other displays, including the Player credit display 40, the credits wager display 41, the Player Point account display 42, the winning Player Points display 43, the Cache Points display 44 and the Draw image display 45.

The gaming machine 10 also includes a button panel 50, which includes several buttons to be used by the Player to input guesses and other decisions. During game play, the Player may make a guess using the Red Hand button 51, the Blue Hand button 52 or the Cache button 53. After a game is over, the Player can begin a new game using the Play Again button 55 if he possesses sufficient credits. Alternatively, after a game is over, the Player can collect any remaining credits using the Collect button 56.

The gaming machine 10 includes a currency acceptor 60 which is used by the Player to insert money and so purchase credits. The gaming machine 10 includes a ticket printer 61 which can issue a ticket to the Player showing the number of credits he possesses and which can be redeemed by a house clerk or other house employee.

The Player begins play by approaching the gaming machine 10 and inserting money into the currency acceptor 60. The gaming machine validates the currency and displays the number of credits purchased on the Player credit display 40. When the player has purchased sufficient credits to begin the game as shown on the credits wager display 41, the game begins. The gaming machine 10 will subtract the wagered number or credits from the Player's account and show the show the changed number of credits on the Player credit display 40.

The gaming machine 10 will then display the initial number of Player Points in the Player Point account display 42. In the preferred embodiment, this number of Player Points will be exactly half the number needed to win the game as shown in the winning Player Points display 43. A bout then begins.

To begin a bout, the gaming machine 10 will display the Red Hand image 31, the Blue Hand image 32 and the Cache image 33. The Red Hand image 31 will periodically be moved to a different location on any of the Red Hand locations 34 or Red/Blue locations 36. The Blue Hand image 32 will periodically be moved to a different location on any of the Blue Hand locations 35 or Red/Blue locations 36.

The Player may at any time guess as to whether the Marker is presently associated with the Red Hand image 31 by pushing the Red Hand button 51. Alternatively, the Player may at any time guess as to whether the Marker is presently associated with the Blue Hand image 32 by pushing the Blue Hand button 52. The Player may at any time guess as to whether the Marker is associated with the Cache image 33 by pushing the Cache button 53.

If the Player makes a guess when both the Red Hand image 31 and the Blue Hand 32 image simultaneously occupy the same Red/Blue location 36, the guess is not valid and the Draw image display 45 will be shown. The gaming machine 10 will then redisplay the Red Hand image 31 and the Blue Hand image 32 in new locations and resume normal play.

If the player makes a guess when the Red Hand image 31 and the Blue Hand image 32 do not simultaneously occupy the same Red/Blue location 36, the guess is valid. The gaming machine will reveal the site of the Marker in either the Red Hand image 31, the Blue Hand image 32 or the Cache image 33. The Player will gain one or more Player Points for a correct guess. The Player will lose a Player Point for each incorrect guess. The gaming machine will display the changed number of Player Points in the Player Point account display 42.

If the changed number of Player Points is zero, the Player has lost the game. If he has sufficient credits remaining as shown in the Player credits display 40, the Player may begin a new game by pushing the Play Again button 55. Alternatively, if the Player has credits remaining, he may press the Collect button 56. The gaming machine will then dispense his credits in the form of a ticket dispensed by the ticket printer 61.

If, following a valid guess, the changed number of Player Points as shown in the Player Point account display 42 is enough to win the game as shown on the winning Player Points display 43, the Player has won the game. As a result, he is awarded the number of credits associated with a win. In the preferred embodiment of the game, this will be exactly double the number of credits he bet at the start of the game. The gaming machine will display the changed number of credits in the Player credit display 40. The Player may begin a new game by pushing the Play Again button 55. A new game will then begin. Alternatively, he may press the Collect button 56. The gaming machine 10 will then dispense his credits in the form of a ticket dispensed by the ticket printer 61.

If, following a valid guess, the changed number of Player Points as shown in the Player Point account display 42 is greater than zero but less than the number needed to win the game as shown on the winning Player Points display 43, the game will continue with a new bout, as previously described.

The preferred embodiment of the game includes the Red Hand image 31, Blue Hand image 32 and Cache image 33 as possible virtual objects with which the Marker could be associated. Another embodiment of the game would not use the Cache image 33 as a possible virtual object with which to associate the Marker. In such an embodiment, a house percentage could be maintained by, at the beginning of the game, setting the number of initial Player Points provided to the Player as shown in the Player Points account display 42 as less than exactly half the number needed to win the game as displayed in the winning Player Points display 43. This would result in the Player being statistically likely to more often lose than to win the game.

Another embodiment would, by a random or other process, set a variable number of initial Player Points provided to the Player as shown in the Player Points account display 42. In the case of the Player being given less than exactly half the number of Player points needed to win as shown in the winning Player Points display 43, this would result in the Player being statistically likely to more often lose than to win the game. In the case of the Player being given more than exactly half the number of Player points needed to win as shown in the winning Player Points display 43, this would result in the Player being statistically likely to more often win than to lose the game. The random or other process used to set the number of initial Player Points could be adjusted to produce a desired statistical likelihood of the Player's winning and so maintain a house percentage.

Another embodiment of the game would utilize more than one Cache as possible virtual object with which the Marker could be associated.

### FIG. 2

FIG. 2 is a flow chart of the play of the new game.

A Player wishing to play the game must possess sufficient credits to do so, either by purchasing them 210 or by continuing to play following a previous game 211. (Details in FIG. 3.) The Player's wager may be equal to or less than the number of credits in his possession.

The game program sets and displays the initial number of Player Points in the Player's account 212. The number of Player Points does not necessarily correspond to the number of credits wagered. The initial number of Player Points may be fixed or may be varied by a random or other process. The number of Player Points needed to win the game and the number of Player Points awarded for a successful Cache guess are displayed or may be permanently displayed. The number of Player Points needed to win the game and the number of Player Points awarded for a successful Cache guess are fixed.

If the game is already in play, the number of Player Points in the Player's account may have changed in the course of the play 213 as determined by the Determine Match loop shown in FIG. 3.

The game program next sets the initial locations of the Red Hand and Blue Hand and sets the initial Marker Site to either the Red Hand, to the Blue Hand or to the Cache 214. The initial positions of the Hands may be determined by a random or other process or be fixed. The initial Marker Site is determined by a random or other process.

Once the two Hand locations and the Marker Site are set, the Player may guess the Marker Site at any time 215. The game program, at periodic intervals, determines whether a guess has been made 216. The periodic intervals may be constant or variable and may correspond to a chant, song or other accompaniment.

If the game program determines that the Player has attempted a guess 216, the game program determines whether the Red and Blue Hands occupy the same location 217. Valid guesses are not allowed when the Red and Blue Hands are in the same location. If the Player attempts to guess when the two Hands are in the same location, the game displays “Draw” 218 or a message with similar meaning.

The game program may then change the location of the Red Hand, Blue Hand, both or neither 219. The determination of which change will be applied is decided by a random, preset or other process. The game program then determines whether the Red and Blue Hands occupy the same location 221.

If the two Hands occupy the same location 221, the game program resets the Marker Site to either of the two Hands or to the Cache 222, using a random or other process. The game program then determines whether to change the location of the Red Hand, Blue Hand, both or neither 219 and proceeds as previously described.

If the two Hands do not occupy the same location 221, the game program periodically determines whether a guess has been made 216, and proceeds as previously described.

If the game program determines that the Player has attempted a guess 216, and that the Red and Blue Hands do not occupy the same location 217, the game program determines whether a match has been made 220. The process for determining whether a match has been made and the consequences of this determination are illustrated in FIG. 3 and described in the Detailed Description for FIG. 3.

If the game program determines that the Player has not attempted a guess 216, the game program may change the location of the Red Hand, Blue Hand, both or neither 219. The determination of which change will be applied is decided by a random, preset or other process. The game program then determines whether the Red and Blue Hands occupy the same location 221.

If the two Hands occupy the same location 221, the game program resets the Marker Site to either of the two Hands or to the Cache 222, using a random or other method. The game program then determines whether to change the location of the Red Hand, Blue Hand, both or neither 219 and proceeds as previously described.

If the two Hands do not occupy the same location 221, the game program periodically determines whether a guess has been made 216, and proceeds as previously described.

### FIG. 3

FIG. 3 is a flow chart of the Determine Match decision loop of the new game. Valid guesses made by the Player 216 217, as described in FIG. 2 and its detailed description, are sent to the start of this loop 220 for evaluation. Following this evaluation, the consequences of the evaluation are also carried through in this loop.

The Player's guess as to the Marker Site is evaluated by the game program 225 to see if it matches the actual Marker Site as previously set by the game program 214 222 as indicated in FIG. 2.

If the Player's guess as to the Marker Site is not correct, one Player Point is subtracted from the Player's account 226. The game program then evaluates whether the remaining number of Player Points in the Player's account is zero 227. If the number of Player Points is zero, the Player has lost and the game is over 236.

If the Player still has points remaining after an incorrect guess and point loss 227, the game continues 213 with a new bout as indicated in FIG. 2.

If the Player's guess as to the Marker Site is correct, the game program determines whether the Marker Site was in the Cache rather than in one of the Hands 228. If the Marker Site was in one of the Hands, one Player Point is added to the Players account 229. If the Marker Site was in the Cache, the Cache number of Player Points are added to the Player's account, up to a maximum of the number needed to win the game 230.

After the Player Point(s) is/are added to the Player's account, the game program evaluates whether the Player has enough Player Points to win the game 231. If the Player does not have enough Player Points to win, the game continues 213 with a new bout as indicated in FIG. 2.

If the Player does have enough Player Points to win the game 231, the game program adds the winning number of credits 232 to the Player's credit account. The number of credits so awarded is normally exactly double the number of credits the Player initially wagered 210 or 211 as shown in FIG. 2.

The Player is then asked if he wishes to play again 233. If he wishes to play again, a new game commences 211 as indicated in FIG. 2.

If the Player does not wish to play again, the game program issues his winnings 234. The winnings may be issued electronically, mechanically or by other means. The game is then over 236.

What is claimed is:

1. A method of playing a game in which a player serially attempts to guess the location of a marker, comprised of the player:
beginning the game in possession of a number of points,
participating in one or more bout(s) within each game,
guessing, within each bout, the location of a marker, such location being previously set by the game program in one of two hands or in a cache,
winning an additional point or points with each correct guess or losing a points or points with each incorrect guess and
accumulating a predetermined number of points to win the game or losing all points to lose the game.

2. The method as recited in claim 1 without the use of a cache as a possible marker location.

3. The method as recited in claim 1 with the inclusion of multiple caches as possible marker locations.
